(19) United States
(12) Patent Application Publication
(10) Pub. No.: US 2016/0294893 A1
(43) Pub. Date: Oct. 6, 2016

(54) ORGANIZING CONVERSATIONS IN COMMUNICATION NETWORKS

(71) Applicant: ShoreTel, Inc., Sunnyvale, CA (US)

(72) Inventor: Michael S. W. Tovino, Bend, OR (US)

(21) Appl. No.: 14/679,453

(22) Filed: Apr. 6, 2015

(51) Int. Cl. H04L 29/06; H04L 12/58; H04M 7/00

(52) U.S. Cl. CPC H04L 65/4007; H04M 7/006; H04L 65/403; H04L 51/16; H04L 51/04

(57) ABSTRACT

A method for organizing communications between parties in a Voice over Internet Protocol (VoIP) system includes monitoring, a plurality of different forms of communication between a first party associated with the VoIP client application and other parties, at least some of the plurality of different forms of communication provided by different communication servers. The method includes assigning, by the VoIP client application, a conversation tag to a communication fragment between the first party and one or more of the other parties, the conversation tag corresponding to the first party and one or more of the other parties. The method further includes forming, at the VoIP client application, a conversation history between the first party and the one or more of the other parties by identifying in a memory the communication fragment based on the associated conversation tag and at least one other communication fragment associated with the same conversation tag.

### FIELD OF INVENTION

Embodiments described herein relate generally to organizing conversations containing various forms of communication in communication networks.

### BACKGROUND

Communication systems that enable communication over a network, such as a Voice over Internet Protocol (VoIP) system, play an increasingly important role in lowering operating cost, especially for large companies with international locations. Instead of subscribing to individual telephone lines for each telephone device, a company is able to purchase or subscribe to a communication system that allows users to communicate internally amongst the employees over a network at a relatively low cost, while allowing users to share a manageable number of external telephone lines. Typically, a server controls voice-related forms of communication, such as, but not limited to, phone calls, video chats, voicemail, call history, and contacts between users in a network. Other forms of communication utilized by the company may be provided by other servers. For instance, instant messaging (IM) and conferencing (e.g., using a conferencing device) may each be provided by a separate server unrelated to the server that provides voice-related forms of communication. Due to the increasing importance of communication over a network, improved methods for such communication systems are constantly desired.

### SUMMARY

Embodiments described herein provide improved methods for communication systems in a network. Specifically, a plurality of communication fragments between a group of parties can be organized into one conversation. Organizing the communication fragments includes assigning a conversation tag to each communication fragment. The conversation tag may correspond to the group of parties that are having the conversation. Thus, a conversation between the group of parties can be organized based upon the conversation tag.

As an example, in accordance with an embodiment, a method for organizing communications between parties in a VoIP system includes monitoring, by a VoIP client application, a plurality of different forms of communication between a first party associated with the VoIP client application and other parties, the plurality of different forms of communication including at least two of voice communication, conference communications, and instant messaging communications, at least some of the plurality of different forms of communication provided by different communication servers. The method may include assigning, by the VoIP client application, a conversation tag to a communication fragment between the first party and one or more of the other parties, the communication fragment generated by a communication between the first party and the one or more of the other parties using at least one of the different forms of communication, the conversation tag corresponding to the first party and the one or more of the other parties. The method may include storing, by the VoIP client application, the conversation tag and the communication fragment in a memory. The method may further include forming, at the VoIP client application, a conversation history between the first party and the one or more of the other parties by identifying in the memory the communication fragment based on the associated conversation tag and at least one other communication fragment associated with the same conversation tag, wherein the communication fragment and the at least one other communication fragment are from communications between the first party and the one or more of the other parties. The method may further still include displaying, at the VoIP client application, the conversation history.

In an embodiment, the communication fragment is sent in a form of communication provided by a first communication server of the different communication servers, and the at least one other communication fragment is sent in a form of communication provided by at least a second server of the different communication servers, wherein the first and second servers are unable to directly communicate with each other. In another embodiment, the conversation tag includes at least one string. The VoIP client application may be run on an application server. In an embodiment, the communication fragment is a phone call, and the at least one other communication fragment is an instant message (IM). In an embodiment, the conversation history may include a list of all communication fragments corresponding to the first party and the one or more of the other parties. The list of all communication fragments may be arranged in chronological order. Each of the different communication servers may be unable to directly communication with others of the different communication servers.

In an embodiment, a method for organizing communications between parties in a VoIP system includes monitoring, by a VoIP client application, a plurality of different forms of communication between a first party associated with the VoIP client application and other parties, at least some of the plurality of different forms of communication provided by different communication servers. The method may include assigning, by the VoIP client application, a conversation tag to a communication fragment between the first party and one or more of the other parties, the conversation tag corresponding to the first party and the one or more of the other parties. The method may further include forming, at the VoIP client application, a conversation history between the first party and the one or more of the other parties by identifying in a memory the communication fragment based on the associated conversation tag and at least one other communication fragment associated with the same conversation tag.

In another embodiment the communication fragment may be generated by a communication between the first party and the one or more of the other parties using at least one of the different forms of communication. In an embodiment, the plurality of different forms of communication includes at least two of voice communications, conference communications, and instant messaging communications. The communication fragment may be sent in a form of communication provided by a first communication server of the different communication servers, and the at least one other communication fragment is sent in a form of communication provided by at least a second server of the different communication servers. In an alternative embodiment, the communication fragment and the at least one other communication fragment are from communications between the first party and the one or more other parties.

In an embodiment, a system for organizing communication between parties includes a plurality of different communication servers, and an application server containing software for a VoIP client application. The VoIP client application may be configured to monitor a plurality of different forms of communication between a first party associated with the VoIP client application and other parties, the plurality of different forms of communication provided by the plurality of different communication servers. The VoIP client application may also be configured to assign a conversation tag to a communication fragment between the first party and one or more of the other parties, the conversation tag corresponding to the first party and the one or more of the other parties. The VoIP client application may be further configured to form a conversation history between the first party and the one or more of the other parties by identifying in a memory the communication fragment based on the associated conversation tag and at least one other communication fragment associated with the same conversation tag.

In an embodiment, a computer-implemented system includes one or more processors, and a non-transitory computer-readable storage medium containing instructions configured to cause the one or more processors to perform operations including monitoring, by a VoIP client application, a plurality of different forms of communication between a first party associated with the VoIP client application and other parties, at least some of the plurality of different forms of communication provided by different communication servers. The non-transitory computer-readable storage medium may also contain instructions configured to assign, by the VoIP client application, a conversation tag to a communication fragment between the first party and one or more of the other parties, the conversation tag corresponding to the first party and the one or more of the other parties. The non-transitory computer-readable storage medium may further contain instructions configured to form, at the VoIP client application, a conversation history between the first party and the one or more of the other parties by identifying in a memory the communication fragment based on the associated conversation tag and at least one other communication fragment associated with the same conversation tag.

Numerous benefits are achieved using embodiments described herein over conventional techniques. For example, in some embodiments, a conversation composed of different forms of communication can be organized into one chronological conversation, regardless of whether or not backend servers that provide the forms of communication are able to communicate with one another. In such embodiments, the backend servers do not need to be reconfigured and/or upgraded to communicate with one another, thereby saving cost. Additionally, the conversation can be organized by a client application, which does not require the client server to have any knowledge of whether the backend servers are able to communicate with one another. In such embodiments, organization of conversations is substantially simplified. Depending on the embodiment, one or more of these benefits may exist. These and other benefits are described throughout the specification.

### BRIEF DESCRIPTION OF THE DRAWINGS

FIGS. 1-2 are simplified diagrams of exemplary communications systems in which some embodiments may be implemented;

FIG. 3 is a simplified diagram of an exemplary server arrangement for a site in a communication system in accordance with some embodiments;

FIGS. 4A and 4B are simplified diagrams of parties having conversations in a communication system in accordance with some embodiments;

FIG. 5 is a flowchart providing a method for organizing a conversation in a communication system in accordance with some embodiments; and

FIG. 6 is a simplified diagram of an exemplary display output for a party in a conversation in accordance with some embodiments.

### DETAILED DESCRIPTION

Embodiments described herein provide improved methods for organizing a conversation in a communication system. The communication system may include a plurality of different servers that each provide a different form of communication. The servers may include client servers as well as backend servers. In some embodiments, the backend servers are unable to communicate with each other, but the client server is able to communicate with each backened server. Thus, the client server can organize the conversation between the different backend servers by utilizing a conversation tag, as will be discussed further herein.

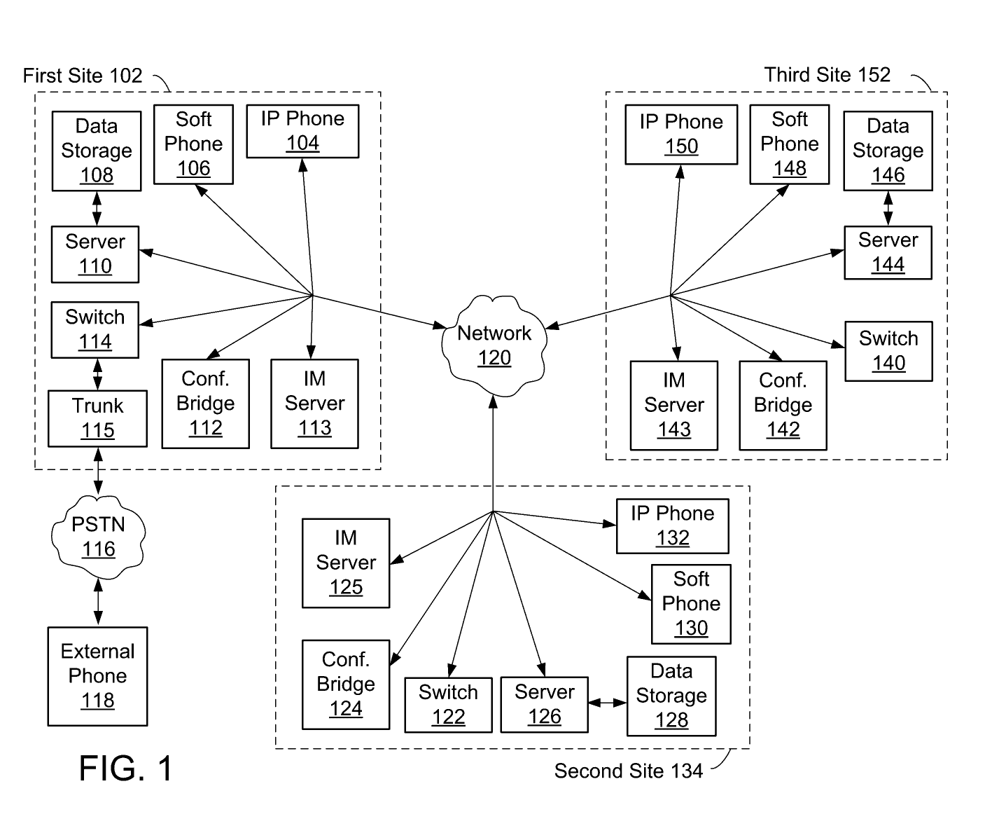

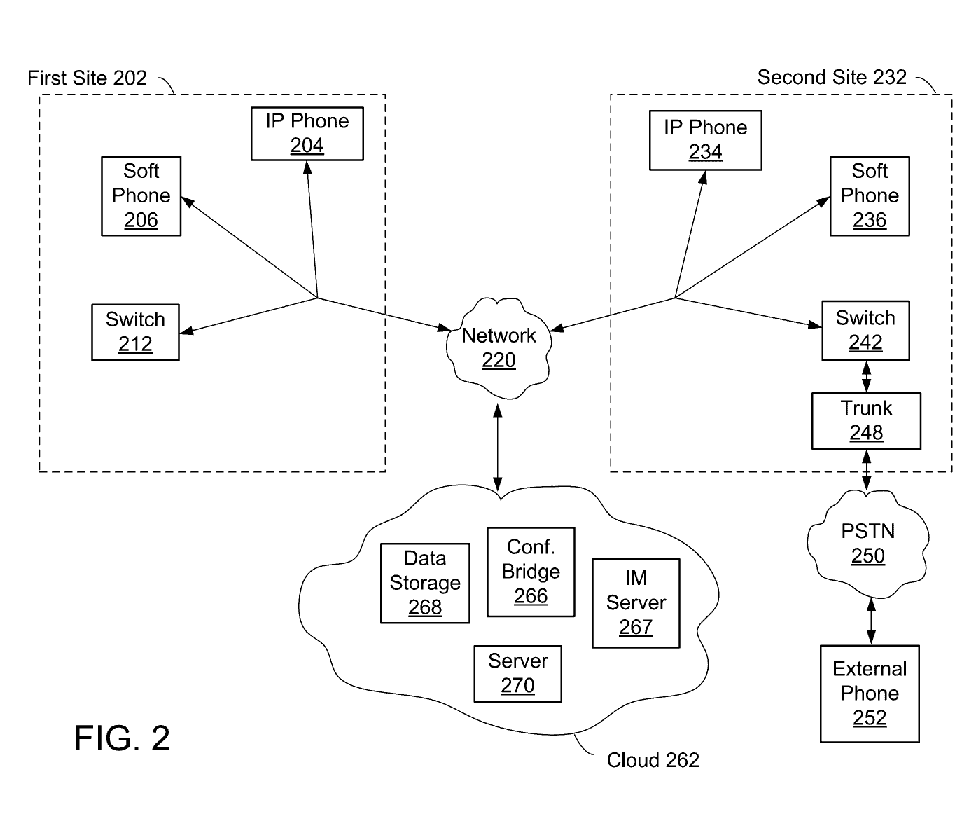

FIGS. 1-2 are simplified diagrams of exemplary communications systems in which some of the embodiments described herein may be implemented. These systems are provided merely as examples and are not intended to limit the various embodiments described. The system illustrated in FIG. 1 includes three groupings of devices labeled as first site 102, second site 134, and third site 152. These sites and the associated devices may form part of a VoIP system. As used herein, a site represents a grouping (e.g., a physical or logical grouping) of resources. The resources may be grouped according to location, in which case different sites may be physically distinct from each other, or they may be grouped based on other factors, in which case different sites may or may not be physically distinct from each other.

While the system illustrated in FIG. 1 has three sites that each include similar devices, embodiments of the present invention are not limited to this configuration. For example, embodiments may be implemented in systems with more or fewer than three sites, and each site may include different devices and configurations compared to the other sites in the system. Differences between the sites illustrated in FIG. 1 are intended to convey the idea that embodiments described herein may be implemented using many different system and/or site configurations.

In this example, the first site 102, the second site 134, and the third site 152 are each communicatively coupled via a network 120. The network 120 may be the Internet or another packet switched network over which the VoIP system operates.

The first site 102 includes several devices including a server 110, a conferencing device 112, a switch 114, a trunk 115, and an instant messaging (IM) server 113. The first site 102 also includes communication devices such as an Internet Protocol (IP) phone 104 and a soft phone 106. Also included within the first site 102 is a data storage device 108. Each of these devices may communicate with each other via the network 120 or via a local network.

The server 110 may be configured to provide some of the applications in the VoIP system. For example, the server 110 may be configured to provide applications such as auto attendant features, media on hold (MOH), voicemail services, and the like. The server 110 may also be configured to provide a client application that can organize a conversation in accordance with embodiments of the present invention. The server 110 may store data in local memory or in the data storage 108.

In an embodiment, the server 110 may be linked directly to the data storage 108 as shown in FIG. 1. In another embodiment, the server 110 may be linked to the data storage 108 via the network 120 or a local network. The data storage 108 is configured to store and maintain data. The data storage 108 may be any conventional storage device or database, such as those powered by My SQL, Oracle, Sybase, and the like, or any other data source such as an LDAP server.

The conferencing device 112 may be configured to link participants (e.g., users of IP phones 104, 132, 150; soft phones 106, 130, 148; and/or other endpoints) in a conference call and enable the sharing of resources between the participants. A conferencing device may also provide conferencing services such as recording and reporting functions. A conferencing device typically includes a number of ports each configured to provide one or more resources (e.g., audio, video, web and/or the like) to a conference participant. The number of participants that can join a conference call is typically limited by the number and configuration of the ports on the conferencing device hosting the conference combined with other hardware and software limitations (e.g., CPU resources, available memory, and the like).

The switch 114 may be a telephone switch that communicates with the IP phone 104 and the soft phone 106 to establish communications channels that are used to make and receive calls. As used herein, the term “calls” refers broadly to any type of communications (e.g., phone calls, conference calls, video calls, text messaging, or other communications). The switch 114 may manage call setup and resource allocation by provisioning extensions for the IP phone 104 and the soft phone 106. In the example illustrated in FIG. 1, the switch 114 is also coupled to the trunk 115. The switch 114 may be coupled directly to the trunk 115 or they may be coupled via the network 120 or a local network.

The IM server 113 may be a server that provides instant messaging services to users of the first site 102. Although FIG. 1 illustrates the IM server 113 located at the first site 102, embodiments where the IM server 113 is located offsite as a remote server are envisioned herein as well.

Other communication devices that are used to make or receive calls may also be included within the VoIP system and within each site. For example, although not shown in this example, a VoIP system may include analog or digital phones, button boxes, “virtual phones” (e.g. extensions that are not assigned to a specific device), and other communication devices. Both fixed and mobile devices may be part of the VoIP system. Moreover, such devices may be part of the VoIP system temporarily or on a more permanent basis. For example, a desktop phone at an enterprise may be a more permanent part of a VoIP system. Alternatively, a mobile device may be part of a VoIP system on a more transient basis, such as when the mobile device is at a particular location and/or during a certain period of time. Additionally, a user may use a call manager program to make, receive, and manage calls within the VoIP system. Such a program may run on a user's phone or on a separate communication device.

The trunk 115 may be an analog, digital, or IP trunk (e.g., a session initiation protocol (SIP) trunk). In the illustrated configuration, the trunk 115 provides an interface between the VoIP system and the public switched telephone network (PSTN) 116. The trunk 115 facilitates inbound and outbound calls between endpoints within the VoIP system (e.g., IP phones 104, 132, 150 and softphones 106, 130, 148) and endpoints accessible via the PSTN 116 (e.g., external phone 118) or via other telephony systems.

The server 110, conferencing device 112, switch 114, trunk 115, and IM server 113 typically include familiar software and hardware components. For example, they may include operating systems, processors, local memory for storage, I/O devices, and system buses interconnecting the hardware components. RAM and disk drives are examples of local memory for storage of data and computer programs. Other types of local memory include magnetic storage media, optical storage media, flash memory, networked storage devices, and the like.

In some embodiments, the server 110 may include more than one server (e.g. a server cluster). Also, in some embodiments the server 110 may be configured to implement some or all of the features that are normally provided by the conferencing device 112, the switch 114, the trunk 115, and/or the IM server 113. Alternatively, the switch 114 may be configured to implement some or all of the features that are normally provided by the server 110, the conferencing device 112, the trunk 115, and/or the IM server 113.

In the VoIP system illustrated in FIG. 1, the second site 134 includes several devices including a server 126, a conferencing device 124, a switch 122, and an IM server 125. The second site 134 also includes communication devices such as an IP phone 132 and a soft phone 130. Also included within the second site 134 is a data storage device 128. Similar to the devices within the first site 102, each of these devices may communicate with each other via the network 120 or via a local network. Each of the devices within the second site 134 may be configured in a manner similar to the corresponding devices within the first site 102 described above.

In a similar manner, the third site 152 includes several devices including a server 144, a conferencing device 142, a switch 140, and an IM server 143. The third site 152 also includes communication devices such as an IP phone 150 and a soft phone 148. Also included within the third site 152 is a data storage device 146. Similar to the devices within the other sites, each of the devices within the third site 152 may communicate with each other via the network 120 or via a local network. Each of the devices within the third site 152 may be configured in a manner similar to the corresponding devices within the first site 102 described above.

FIG. 1 is presented merely as an exemplary VoIP system to illustrate some of the features and functionality of the present invention. Not all distributed VoIP systems include the devices shown in FIG. 1. Likewise, some distributed VoIP systems include additional devices that are not shown. For example, in some configurations, the devices shown in FIG. 1 may be combined or provide functionality that is different from that described herein. Thus, the present invention can be implemented in many different VoIP systems and should not be construed as limited to the configurations set forth herein.

In accordance with some embodiments, virtual machines may be used to replace devices in systems such as the VoIP system illustrated in FIG. 1. Examples of some of the devices in a VoIP system that may be replaced by one or more virtual machines include conferencing devices, phone switches, trunks, session border controllers, routers, and the like. One of the benefits of virtual machines is that scale is essentially determined by the computing power and memory of the virtual machine, so a single virtual machine could in theory seamlessly scale from very small to very large capacities.

FIG. 2 is another example of an exemplary communications system where some of the devices are in a cloud 262. The cloud 262 allows sharing of resources between different sites (and possibly different communications systems). Devices in the cloud 262 may be physical devices or virtual machines.

This figure provides another example of a system in which some of the embodiments described herein may be implemented. The communications system includes a first site 202 and a second site 232. The first site 202 includes an IP phone 204, a soft phone 206, and a switch 212. The second site includes an IP phone 234, a soft phone 236, a switch 242, and a trunk 248. The trunk 248 facilitates inbound and outbound calls between endpoints within the communications system and endpoints outside the communications system (e.g., external phone 252).

In this example, neither of the sites include a conferencing device or an IM server. Instead, a conferencing device 266 and an IM server 267 are provided in the cloud 262. The cloud also includes a server 270 and data storage 268. These devices may be configured to provide applications and/or services to the devices at both the first site 202 and the second site 232.

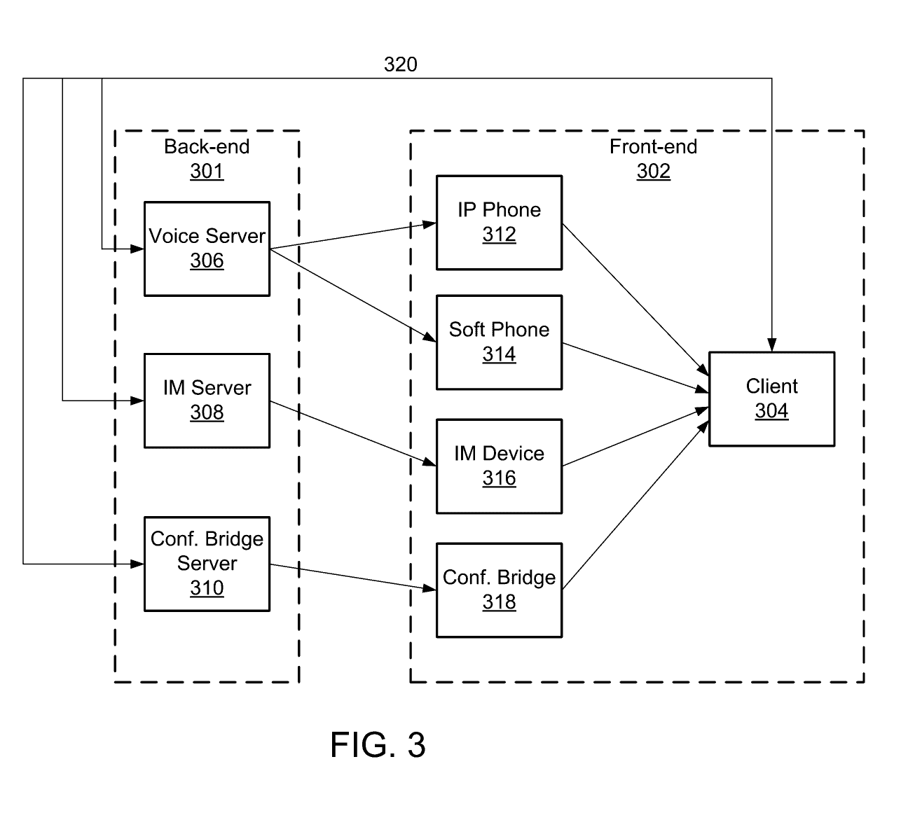

Some embodiments described herein relate to a conversation between multiple parties containing more than one form of communication provided by different servers. FIG. 3 shows a server organization of an exemplary VoIP system for a single site. The VoIP system may include a back-end 301 and a front-end 302. The back-end 301 may include a plurality of servers that provide support for devices and/or servers in the front-end 302. The devices and/or servers in the front-end 302 directly interact with users who may interact with the VoIP system.

In an embodiment, each back-end server may provide communication services to one or more devices. For instance, a voice server 306, such as an Internet Protocol Private Branch Exchange (IP PBX) server, may provide voice service, such as, but not limited to, phone calls, voicemail, video chat, call history, and contact list management, for an IP phone 312 and/or a soft phone 314. An IM server 308 may provide instant messaging service to an IM device 316, which may be any suitable device capable of allowing a user to input a message. An exemplary IM device may be a smartphone, a computer, or a tablet. Additionally, a conference server 310 may provide conferencing services to a conferencing device 318.

In embodiments, the servers 306, 308, and 310 may or may not be able to communicate with one another. If the servers are unable to communicate with one another, the voice server 306 may not know whether the IM server is providing IM services to the IM device 316, or whether the conference server 310 is providing conferencing services to the conferencing device 318. It may therefore be difficult to consolidate a conversation containing multiple forms of communication that utilize multiple backend servers. According to an embodiment of the present invention, a client server, such as server 110 in FIG. 1, contains a client application 304, and may be communicatively coupled to all the servers, e.g., the voice server 306, the IM server 308, and the conference server 310 through a communication means 320. The communication means 320 may be established by any suitable connection, such as a wireless connection through a network or a cloud. As such, the client application 304 may be able to monitor the back-end servers and know when they are providing services to devices in the network, such as device 312, 314, 316, and 318.

Additionally, the client application 304 may be communicatively coupled to the devices in the network. For instance, the client application 304 may be coupled to the IP phone 312, soft phone 314, IM device 316, and conferencing device 318. Thus, the client application 304 may be aware of operations of the devices 312, 314, 316, 318 as well as the servers 306, 308, and 310. Accordingly, the client may be able to organize conversations made in the VoIP system.

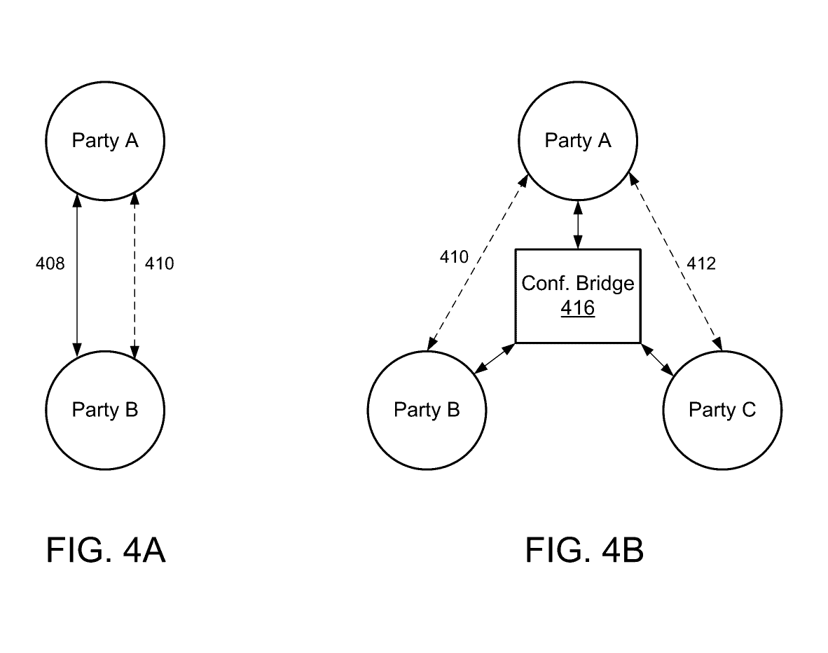

FIGS. 4A and 4B illustrate scenarios where a conversation is occurring between two or more parties. Specifically, FIG. 4A illustrates a conversation between party A and party B. The conversation may include an ongoing voice conversation, such as a phone call 408. In addition, party A and party B may be having an IM conversation 410 concurrently with the phone call 408. For instance, party A and party B may be in a phone conversation discussing the terms of a business contract. To help facilitate the phone conversation, party A may want to send party B the exact wording of a provision of the contract so that party B may peruse the provision for himself or herself during the phone call 408. In this case, the phone call 408 may be provided by a voice server, e.g., the voice server 306, and the IM conversation 410 may be provided by an IM server, e.g., the IM server 308. Thus, the conversation between party A and party B may be composed of both a phone call 408 and an IM conversation 410.

Briefly referencing another embodiment depicted in FIG. 4B, a single conversation may be made between three parties: party A, party B, and party C. A conference bridge 416 may be established between the three parties to allow voice communication and/or video chat. Although all three parties may be in a conference bridge 416, party A and party B may be having a separate IM conversation 410. Additionally, party A and party C may be having a separate IM conversation 412 as well. Accordingly, there are three conversations occurring at the same time. One conversation is between party A, party B, and party C; another conversation is between party A and party B; and the final conversation is between party A and party C.

With reference back to FIG. 4A, if a voice server (e.g., voice server 306) is not able to communicate with an IM server (e.g., IM server 308), the voice server 306 may not know that IM messages 410 are being sent between party A and party B. However, because the client application 304 is able to communicate with the servers 306 and 308, the client application 304 may organize the phone call 408 and the IM conversation 410 as one conversation between party A and party B, according to an embodiment of the present invention.

To organize the conversation between party A and party B, the conversation may be divided into a plurality of communication fragments. A communication fragment may be a single instance in a conversation between party A and party B. As an example, a communication fragment may be a single IM message from party A to party B, or a single, uninterrupted phone call between party A and party B. Additionally, a communication fragment may be a historical phone call, a voice message, a file, a data conference, or a contact card. Although the phone call 408 and the IM 410 may be provided by different servers that are unable to communicate with one another, the client application may still be able to monitor each communication fragment as they are sent in real time because of the communication means 320 established between the servers and the client application, as illustrated in FIG. 3.

According to embodiments of the present invention, a conversation tag is utilized by the client application to organize a conversation between parties, such as party A and party B. The conversation tag may uniquely identify a set of conversation participants. For instance, a unique conversation tag may identify a conversation between only party A and party B (see FIG. 4A), or a conversation between party A, party B, and party C (see the conference bridge 416 in FIG. 4B). In some embodiments, the conversation tag may be arranged to exclude a party of the conversation that is associated with the client application. As an example, if party A is a user of the client application, the conversation tag may uniquely identify only party B. The details of such a conversation tag are discussed herein.

In embodiments, the conversation tag may be a string that includes a variety of information to identify a party in a conversation. If the client application operates with JavaScript, for example, the conversation tag may have the following JavaScript Object Notation (JSON) structure:

```
{
    “cid” : [“id1”, “id2”, “id3”,...],
    “tel” : [“addr1”, ”addr2”, ”addr3”,...],
    “im” : [“addr1”, “addr2”, “addr3”,...]
}
```

where id1, id2, id3, . . . are identifiers from an information source or database, such as, but not limited to, a Client Application Server (CAS) Contact Search and a Buddies Application Programming Interface (API), and addr1, addr2, addr3, . . . are canonical phone numbers or canonical IM addresses.

Referring back to the conversation between party A and party B of FIG. 4A, where party A is running the client application, the conversation tag may be as follows:

```
{
    “cid” : [“B”],
    “im” : [“partyB@company.com”]
}
```

where the identifier only identifies party B because party A, the user of the client application, is having a conversation with only party B. In this embodiment, party B is identified as “B” instead of a canonical phone number because party B is part of the communication network with party A. In other words, party A and party B are part of the same VoIP system, e.g., network 120 of FIG. 1. If party B is not a part of the communication network with party A, but is an external phone call, for instance, party B's canonical phone number may be used as the conversation tag instead, as shown in the following example referencing FIG. 4B.

With reference to the conversation between party A, party B, and party C of FIG. 4B, where party A is running the client application, the conversation tag may be as follows:

```
{
    “cid” : [“B”],
    “tel” : [“+14085551212”],
    “im” : [“partyB@company.com”, “partyC@company.com”]
}
```

where the identifier only identifies party B and party C because party A, the user of the client application, is having a conversation with party B and party C. In this embodiment, party C is not part of the same VoIP system as party A and party B. Thus, party C is identified by a canonical phone number.

It is to be appreciated that the conversation tag may be specific to the parties involved in the conversation irrespective of time elapsed between conversations or forms of communication used during the conversation. For instance, a conversation made between party A and party B may still be considered to be part of the same conversation of a subsequent conversation between party A and party B made several months later. Thus, communication fragments generated in both conversations may be assigned the same conversation tag. Further, a phone call made between party A and party B utilizing only a voice server may still be considered to be part of the same conversation of an IM and phone conversation between party A and party B utilizing a voice server and an IM server.

According to embodiments of the present invention, the conversation tags may be used to organize a conversation. For instance, a client application may gather all the communication fragments assigned with the same conversation tag and display it for a user.

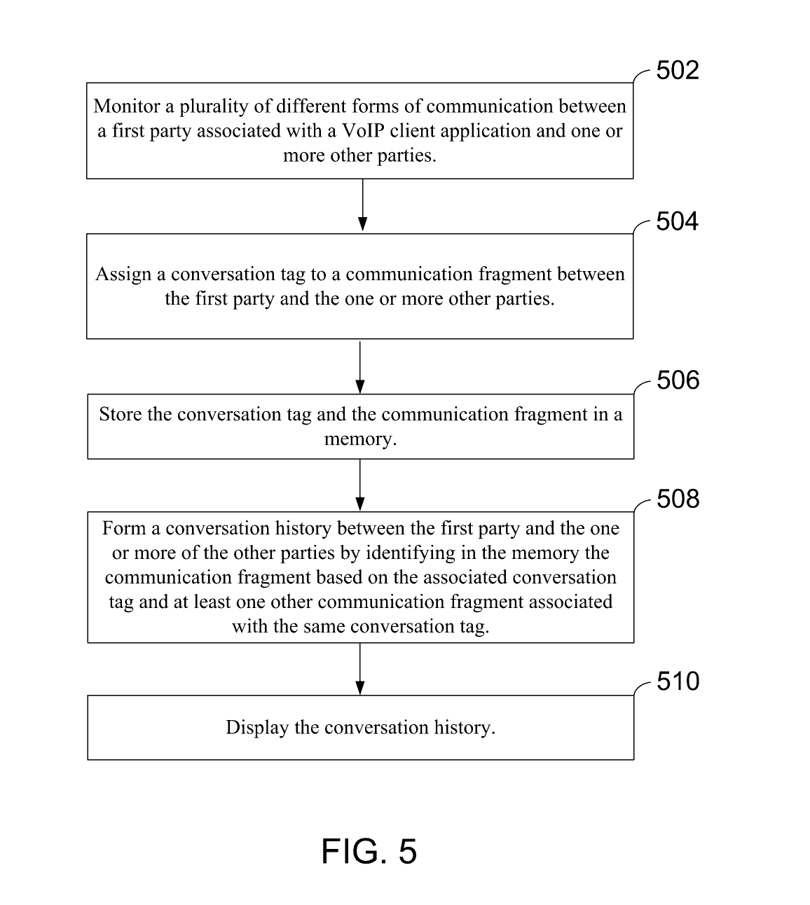

FIG. 5 illustrates a flow diagram of a method of organizing a conversation. At step 502, a client application may monitor a plurality of different forms of communication between a first party associated with a VoIP client application and one or more other parties. The client application may monitor the forms of communication via the communication means 320 illustrated in FIG. 3. The monitoring may be passive so that a separate device does not need to be implemented to monitor the forms of communication. The plurality of different forms of communication may include at least two of voice communications, conference communications, and instant messaging. In an embodiment, at least some of the servers are provided by different communication servers.

At step 504, the client application may assign a conversation tag to a communication fragment between the first party and the one or more other parties. The conversation tag may correspond to the particular parties involved in the communication as discussed herein with respect to FIGS. 4A and 4B. At step 506, the conversation tag and the communication fragment to which the conversation tag is assigned may be stored in a memory. For instance, the conversation may be stored on a storage medium, such as the data storage 108 from FIG. 1, such that the conversation tags may be later retrieved.

At step 508, the client application may form a conversation history between the first party and the one or more other parties by identifying in the memory the communication fragment based on the associated conversation tag and at least one other communication fragment associated with the same conversation tag. The client application may search the memory for communication fragments that are assigned the same conversation tag. Such communication fragments may then be organized together in a logical format, such as in chronological order. The organized communication fragments may form the conversation history.

At step 510, the client application may display the conversation history to a user. For instance, the client application may display the IM messages and/or the phone calls on a computer screen. The user may be advantageously informed of the history of his or her conversation with the other parties through all forms of communication.

It should be appreciated that the specific steps illustrated in FIG. 5 provide particular methods according to some embodiments. Other sequences of steps may also be performed according to alternative embodiments. For example, alternative embodiments may perform the steps outlined above in a different order. Moreover, the individual steps illustrated in FIG. 5 may include multiple sub-steps that may be performed in various sequences. Furthermore, additional steps may be added or removed depending on the particular application.

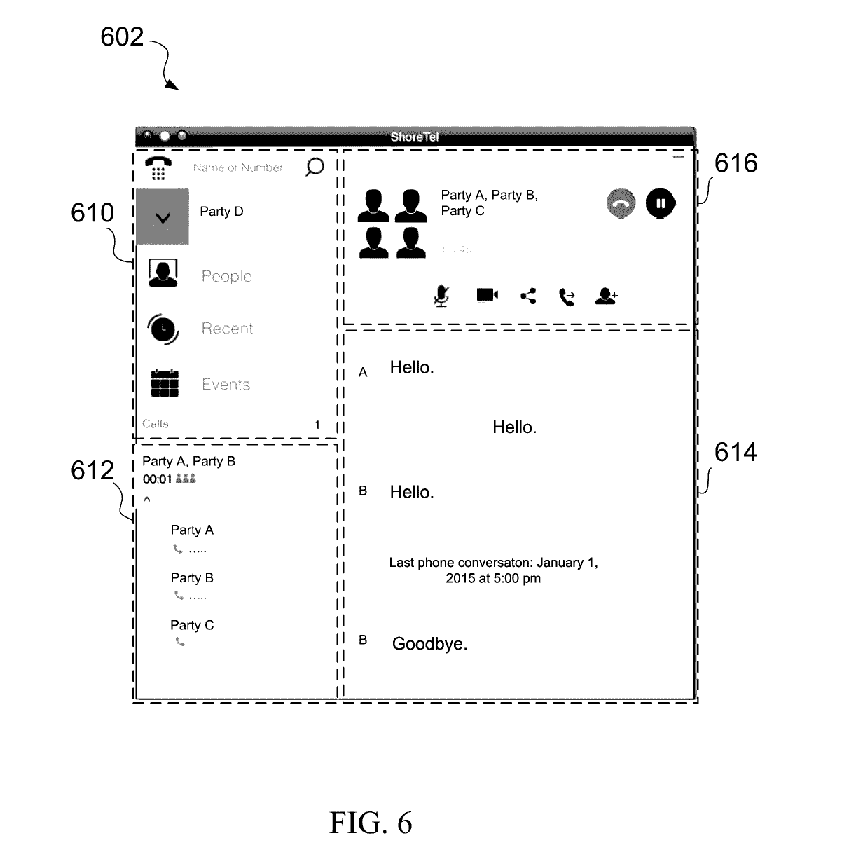

FIG. 6 illustrates an exemplary display output according to embodiments of the present invention. As shown in FIG. 6, display 602 may include several sections, each of which may serve a different function. For instance, the display 602 may include a menu 610, a list of parties 612, a control panel 616, and a conversation history section 614. The menu 610 may allow a user to search through a personnel directory or open a calendar containing upcoming events. The list of parties 612 may list several parties or groups of parties with which the user has held a conversation in the past. The control panel 616 may display parties in a current conversation, allow the user to hang up or dial, and/or allow the user to perform a number of other operations. The conversation history section 614 may display a conversation history with a party selected in the list of parties 612. The conversation history section 614 may include a list of IM messages, phone calls, voice messages, and conferences that have occurred with the party selected in the list of parties 612. It is to be appreciated that the specific placement of the aforementioned sections are merely one embodiment, and that any suitable arrangement of the sections are envisioned herein as well.

In the exemplary embodiment illustrated in FIG. 6, display 602 illustrates an exemplary display output for party D that is running a client application according to an embodiment of the present invention. Party D has previously had a conversation with parties A and B. Selecting the parties A and B in the list of parties section 612 causes the conversation history between, parties A and B to be displayed in the conversation history section 614. The conversation history section 614 displays several IM messages between parties A and B as well as a previous phone conversation between them. Each IM message and phone conversation may be a communication fragment that has been assigned a common conversation tag that corresponds to parties A and B for party D. Even if the IM service and phone service are provided by different servers that are unable to communicate with one another, the client application is able to assign the same conversation tag to each communication fragment and organize the communication fragments into one conversation between the parties according to that conversation tag.

It should be appreciated that some embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may be adapted to perform the necessary tasks. The term “computer-readable medium” includes, but is not limited to, portable or fixed storage devices, optical storage devices, wireless channels, sim cards, other smart cards, and various other non-transitory mediums capable of storing, containing, or carrying instructions or data.

While the present invention has been described in terms of specific embodiments, it should be apparent to those skilled in the art that the scope of the present invention is not limited to the embodiments described herein. For example, features of one or more embodiments of the invention may be combined with one or more features of other embodiments without departing from the scope of the invention. The specification and drawings are, accordingly, to be regarded in an illustrative rather than a restrictive sense. Thus, the scope of the present invention should be determined not with reference to the above description, but should be determined with reference to the appended claims along with their full scope of equivalents.

What is claimed is:

1. A method for organizing communications between parties in a Voice over Internet Protocol (VoIP) system, comprising:
monitoring, by a VoIP client application, a plurality of different forms of communication between a first party associated with the VoIP client application and other parties, the plurality of different forms of communication comprising at least two of voice communications, conference communications, and instant messaging communications, at least some of the plurality of different forms of communication provided by different communication servers;
assigning, by the VoIP client application, a conversation tag to a communication fragment between the first party and one or more of the other parties, the communication fragment generated by a communication between the first party and the one or more of the other parties using at least one of the different forms of communication, the conversation tag corresponding to the first party and the one or more of the other parties;
storing, by the VoIP client application, the conversation tag and the communication fragment in a memory;
forming, at the VoIP client application, a conversation history between the first party and the one or more of the other parties by identifying in the memory the communication fragment based on the associated conversation tag and at least one other communication fragment associated with the same conversation tag, wherein the communication fragment and the at least one other communication fragment are from communications between the first party and the one or more of the other parties; and
displaying, at the VoIP client application, the conversation history.

2. The method of claim 1, wherein the communication fragment is sent in a form of communication provided by a first communication server of the different communication servers, and the at least one other communication fragment is sent in a form of communication provided by at least a second server of the different communication servers, wherein the first and second servers are unable to directly communicate with each other.

3. The method of claim 1, wherein the conversation tag comprises at least one string.

4. The method of claim 1, wherein the VoIP client application is run on an application server.

5. The method of claim 1, wherein the communication fragment is a phone call, and the at least one other communication fragment is an instant message (IM).

6. The method of claim 1, wherein the conversation history comprises a list of all communication fragments corresponding to the first party and the one or more of the other parties.

7. The method of claim 6, wherein all communication fragments in the list are arranged in chronological order.

8. The method of claim 1, wherein each of the different communication servers is unable to directly communicate with others of the different communication servers.

9. A method for organizing communications between parties in a Voice over Internet Protocol (VoIP) system, comprising:
monitoring, by a VoIP client application, a plurality of different forms of communication between a first party associated with the VoIP client application and other parties, at least some of the plurality of different forms of communication provided by different communication servers;
assigning, by the VoIP client application, a conversation tag to a communication fragment between the first party and one or more of the other parties, the conversation tag corresponding to the first party and the one or more of the other parties; and
forming, at the VoIP client application, a conversation history between the first party and the one or more of the other parties by identifying in a memory the communication fragment based on the associated conversation tag and at least one other communication fragment associated with the same conversation tag.

10. The method of claim 9, wherein each of the different communication servers is unable to directly communicate with others of the different communication servers.

11. The method of claim 9, wherein the communication fragment is generated by a communication between the first party and the one or more of the other parties using at least one of the different forms of communication.

12. The method of claim 9, wherein the plurality of different forms of communication comprises at least two different ones of voice communications, conference communications, and instant messaging communications.

13. The method of claim 9, wherein the communication fragment is sent in a form of communication provided by a first communication server of the different communication servers, and the at least one other communication fragment is sent in a form of communication provided by at least a second server of the different communication servers, wherein the first and second servers are unable to directly communicate with each other.

14. The method of claim 9, wherein the communication fragment and the at least one other communication fragment are from communications between the first party and the one or more of the other parties.

15. A system for organizing communication between parties, comprising:
a plurality of different communication servers;
an application server containing software for a VoIP client application, wherein the VoIP client application is configured to:
monitor a plurality of different forms of communication between a first party associated with the VoIP client application and other parties, the plurality of different forms of communication provided by the plurality of different communication servers;
assign a conversation tag to a communication fragment between the first party and one or more of the other parties, the conversation tag corresponding to the first party and the one or more of the other parties; and
form a conversation history between the first party and the one or more of the other parties by identifying in a memory the communication fragment based on the associated conversation tag and at least one other communication fragment associated with the same conversation tag.

16. The system of claim 15, wherein each server of the plurality of the different communication servers is unable to directly communicate with other servers of the plurality of different communication servers.

17. The system of claim 15, wherein the communication fragment is generated by a communication between the first party and the one or more of the other parties using at least one of the different forms of communication.

18. A computer-implemented system comprising:
one or more processors; and
a non-transitory computer-readable storage medium containing instructions configured to cause the one or more processors to perform operations comprising:
monitoring, by a VoIP client application, a plurality of different forms of communication between a first party associated with the VoIP client application and other parties, at least some of the plurality of different forms of communication provided by different communication servers;
assigning, by the VoIP client application, a conversation tag to a communication fragment between the first party and one or more of the other parties, the conversation tag corresponding to the first party and the one or more of the other parties; and
forming, at the VoIP client application, a conversation history between the first party and the one or more of the other parties by identifying in a memory the communication fragment based on the associated conversation tag and at least one other communication fragment associated with the same conversation tag.

19. The computer-implemented system of claim 18, wherein each server of the plurality of the different communication servers is unable to directly communicate with other servers of the plurality of different communication servers.

20. The computer-implemented system of claim 18, wherein the communication fragment is generated by a communication between the first party and the one or more of the other parties using at least one of the different forms of communication.
